(19) United States
(12) Patent Application Publication
(10) Pub. No.: US 2025/0168203 A1
(43) Pub. Date: May 22, 2025

(54) MULTI-CLOUD ASSESSMENT FRAMEWORK FOR DYNAMIC CLOUD WORKLOADS

(71) Applicants: MICHAEL FALLIHEE, Helena, MT (US); DAVIDE MASSARENTI, BOTHELL, WA (US); VIGNESHWARAN ANGAMUTHU, Chennai (IN)

(72) Inventors: MICHAEL FALLIHEE, Helena, MT (US); DAVIDE MASSARENTI, BOTHELL, WA (US); VIGNESHWARAN ANGAMUTHU, Chennai (IN)

(21) Appl. No.: 18/761,283

(22) Filed: Jul. 1, 2024

Related U.S. Application Data
(60) Provisional application No. 63/524,477, filed on Jun. 30, 2023.

(51) Int. Cl. H04L 9/40; H04L 41/5009

(52) U.S. Cl. CPC H04L 63/205; H04L 41/5009

(57) ABSTRACT

In one aspect, a computerized method for explicit and implicit cloud-resource data extraction with a multi-cloud governance platform comprising: providing a plurality of cloud resources; automatically obtaining a cloud resource data for each cloud resource in the plurality of cloud resources; defining a set of Cloud Operations, Security, Cost, Access, and Resource (OSCAR) cloud resources information for a plurality of explicit relationships and a plurality of implicit relationships of each cloud resource of the plurality of cloud resource; defining a plurality of implicit relationships that are derived from a plurality of connections of each cloud resource; obtaining a billing information of each cloud resource; obtaining a third-party data for the cloud resource; obtaining and associating a plurality of relevant standards, policies and regulations for each cloud resource; obtaining one or more relevant regions and other geographical data relevant to each cloud resource; and generating a wholistic view of each cloud resource.

### CLAIM OF PRIORITY

This application claims priority to U.S. Provisional Patent Application No. 63/524,584, filed on Jun. 30, 2023 and titled Process and methods for building a complete view of a cloud resource with explicit, implicit and curation of data for a multi-cloud governance platform. This provisional patent application is hereby incorporated by reference in its entirety.

### BACKGROUND

When it comes to modern-day technology infrastructure, all roads digital lead to and from the cloud. And by any measure you care to examine, cloud usage continues to increase at a rapid pace. According to Gartner, spending on public cloud services grew almost 19% worldwide in 2022, and it's forecast to grow at an even faster rate in 2023, reaching $591.8 billion.1 Longerterm growth looks even stronger, with IDC forecasting that global cloud spend will reach $1.3 trillion by 2025.2 It would seem the digital transformation has only just begun—and is accelerating rapidly. As the use of cloud computing expands, organizations are increasingly recognizing the importance of robust cloud governance. But in order to achieve model cloud governance in today's complex, hybrid, and multi-cloud environments, you need a cloud governance model-one that can take you from cloud chaos to cloud confidence.

### BRIEF SUMMARY OF THE INVENTION

In one aspect, a computerized method for explicit and implicit cloud-resource data extraction with a multi-cloud governance platform comprising: providing a plurality of cloud resources; automatically obtaining a cloud resource data for each cloud resource in the plurality of cloud resources; defining a set of Cloud Operations, Security, Cost, Access, and Resource (OSCAR) cloud resources information for a plurality of explicit relationships and a plurality of implicit relationships of each cloud resource of the plurality of cloud resource; defining a plurality of implicit relationships that are derived from a plurality of connections of each cloud resource; obtaining a billing information of each cloud resource; obtaining a third-party data for the cloud resource; obtaining and associating a plurality of relevant standards, policies and regulations for each cloud resource; obtaining one or more relevant regions and other geographical data relevant to each cloud resource; and with the plurality of implicit relationships that are derived from a plurality of connections of each cloud resource, the billing information of each cloud resource, the third-party data for the cloud resource plurality of relevant standards, the policies and regulations for each cloud resource, and the one or more relevant regions and other geographical data relevant to each cloud resource, generating a wholistic view of each cloud resource.

### BRIEF DESCRIPTION OF THE DRAWINGS

FIG. 1 illustrates an example schematic of an OSCAR governance model, according to some embodiments.

FIG. 2 illustrates an example system for enriching cloud resources, according to some embodiments.

FIG. 3 illustrates an example schematic showing Cloud Governance platform capabilities, according to some embodiments.

FIG. 4 illustrates an example process for multi-cloud platform governance, according to some embodiments.

FIG. 5 illustrates an example process for explicit and implicit cloud-resource data extraction with a multi-cloud governance platform, according to some embodiments.

FIG. 6 is a block diagram of a sample computing environment that can be utilized to implement various embodiments.

The Figures described above are a representative set and are not an exhaustive with respect to embodying the invention.

### DESCRIPTION

Disclosed are a system, method, and article of manufacture for enriching and enhancing cloud resource data with a multi-cloud governance platform. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Amazon Web Services, Inc. (AWS) is an on-demand cloud computing platform(s) and API ( ). These cloud-computing web services can provide distributed computing processing capacity and software tools via AWS server farms. AWS can provide a virtual cluster of computers, available all the time, through the Internet. The virtual computers can emulate most of the attributes of a real computer, including hardware central processing units (CPUs) and graphics processing units (GPUs) for processing; local/RAM memory; hard-disk/SSD storage; a choice of operating systems; networking; and pre-loaded application software such as web servers, databases, and customer relationship management (CRM).

Microsoft Azure (e.g. Azure as used herein) is a cloud computing service operated by Microsoft for application management via Microsoft-managed data centers. It provides software as a service (Saas), platform as a service (PaaS) and infrastructure as a service (IaaS) and supports many different programming languages, tools, and frameworks, including both Microsoft-specific and third-party software and systems.

Cloud computing architecture refers to the components and subcomponents required for cloud computing. These components typically consist of a front-end platform (fat client, thin client, mobile), back-end platforms (servers, storage), a cloud-based delivery, and a network (Internet, Intranet, Intercloud). Combined, these components can make up cloud computing architecture. Cloud computing architectures and/or platforms can be referred to as the ‘cloud’ herein as well.

Cloud resource model (CRM) provides ability to define resource characteristics, Hierarchy, dependencies, and its action in a declarative model and embed them in Open API specification. CRM allows both humans and computers to understand and discover capabilities and characteristics of cloud service and its resources.

Hyperscalers can be large cloud service providers. Hyperscalers can be the owners and operators of data centers where these horizontally linked servers are housed.

Multi-cloud refers to a company utilizing multiple cloud computing services from various public vendors within a single, heterogeneous architecture. This approach can enhance cloud infrastructure capabilities and optimizes costs. It can also refer to the distribution of cloud assets, software, applications, etc. across several cloud-hosting environments.

### Example Systems and Methods

A multi-cloud governance platform is provided that empowers enterprises to rapidly achieve autonomous and continuous cloud governance and compliance at scale. Multi-cloud governance platform is delivered to end users in the form of multiple product offerings, bundled for a specific set of cloud governance pillars based on the client's needs. Example multi-cloud governance platform's offerings and associated cloud governance pillars are now discussed.

The multi-cloud governance platform can provide FinOps as a solution offering that is designed to help an entity develop a culture of financial accountability and realize the benefits of the cloud faster. The multi-cloud governance platform SecOps as a solution offering designed to help keep cloud assets secure and compliant. The multi-cloud governance platform is a solution offering designed to help optimize cloud operations and cost management in order to provide accessibility, availability, flexibility, and efficiency while also boosting business agility and outcomes. The multi-cloud governance platform provides a compass that is designed to help an entity adopt best practices according to well-architected frameworks, gain continuous visibility, and manage risk of cloud workloads with assessments, policies, and reports that allow an administrator to review the state of applications and get a clear understanding of risk trends over time.

Cloud Governance Pillars that can be implemented by the multi-cloud governance platform are now discussed. The multi-cloud governance platform can enable governing of cloud assets involves cost-efficient and effective management of resources in a cloud environment while adhering to security and compliance standards. There are several factors that can be involved in a successful implementation of cloud governance. The multi-cloud governance platform has encompassed all these factors into its cloud governance pillars. The following table explains the key cloud governance pillars developed by Multi-cloud governance platform.

The multi-cloud governance platform utilizes various operations that provide the capability to operate and manage various cloud resources efficiently using various features such as automation, monitoring, notifications, activity tracking.

The multi-cloud governance platform utilizes various security operations that enable management of the security governance of various cloud accounts and identify the security vulnerabilities and threats and resolve them.

The multi-cloud governance platform utilizes various manages cost. The multi-cloud governance platform enables users to create a customized controlling mechanism that can control a customer's cloud expenses within budget and reduce cloud waste by continually discovering and eliminating inefficient resources.

The multi-cloud governance platform utilizes various access operations. The multi-cloud governance platform utilizes various allows administrators to configure secure access of resources in a cloud environment and protect the users' data and assets from unauthorized access.

The multi-cloud governance platform utilizes various resource management operations. The multi-cloud governance platform enables users to define, enforce, and track the resource naming and tagging standards, sizing, and their usage by region. It also enables a customer to follow consistent and standard practices pertaining to resource deployment, management, and reporting.

The multi-cloud governance platform utilizes various compliance actions. The multi-cloud governance platform guides users to assess a cloud environment for its compliance status against standards and regulations that are relevant to an organization-ISO, NIST, HIPAA, PCI, CIS, FedRAMP, AWS Well-Architected framework, and custom standards.

The multi-cloud governance platform utilizes various self-service operations. The multi-cloud governance platform enables administrators to configure a simplified self-service cloud consumption model for end users that are tied to approval workflows. It enables an entity to automate repetitive tasks and focus on key deliverables.

### Example Cloud Governance Platform

The multi-cloud governance platform includes a Cloud Governance platform (e.g. Cloud Resource 360). The Cloud Governance platform can be a single system of intelligence for all cloud resources. The Cloud Governance has the power to transform cloud governance for enterprises of all sizes and across all industries. As the single system of intelligence for all cloud resources, the Cloud Governance provides new levels of visibility and understanding without requiring multiple tools or cumbersome integrations. The Cloud Governance is designed to adapt quickly as cloud technology evolves and as cloud providers introduce new functionality. The Cloud Governance platform can future-proof the multi-cloud governance platform (e.g. AWS, Azure, GCP, OCI, or some combination of hyperscalers).

The Cloud Governance platform provides that view, serving as a single system of intelligence for all cloud resources. The Cloud Governance platform provides a 360-degree view of each cloud resource-a complete perspective that includes anything and everything associated with a given cloud resource. This approach delivers a unified experience with the potential for numerous beneficial outcomes and insights. The Cloud Governance platform provides a single platform that supports multiple disparate capabilities, including FinOps, SecOps, CloudOps, and Well-Architected Assessments, all at the same time simply by leveraging different aspects of the same data from each cloud resource. The Cloud Governance platform is able to associate the cloud resource with relevant workloads, dependencies, projects, and more, giving customers a complete view of each cloud resource by applying multiple lenses to the data.

The Cloud Governance platform provides a “single system of intelligence.” The Cloud Governance platform provides has the capacity not just to provide holistic views of data but also, as mentioned before, to enable beneficial outcomes and insights. The Cloud Governance platform provides the benefits of the single system to the relationship between cloud resources as well- and to all the interdependencies between every facet of a cloud resource. This is not just a view of a single resource but of multiple resources that are connected to each other across multiple workloads and multiple cloud platforms, creating even greater intelligence.

When a customer cloud account is onboarded to CoreStack, the Cloud Governance platform discovers all the cloud resources that belong to the account and bringing that information into the database. In this step, the Cloud Governance platform builds the inventory of all cloud resources. Once the Cloud Governance platform has the inventory, it then determines the detailed properties of each cloud resource from the hyperscalers, and we build the associated relationships between them. The Cloud Governance platform obtains the corresponding billing data for the cloud accounts.

Cloud resources have hierarchies and characteristics, and, for each hierarchy, multiple dimensions, dependencies, and implicit and explicit relationships with other cloud resources. These cloud resources also allow actions that are measured or influenced by cloud-native services or third-party tools. Hyperscalers provide details about each resource through discrete APIs. At this point, the Cloud Governance platform builds a 360-degree view of each of those resources. In one example, a cloud resource can have two views: an inside out view, and an outside in view. The inside out view provides characteristics, implicit relationships, explicit relationships, direct dependencies, indirect dependencies, and actions. The outside in view can be categorized across five essential areas, as follows.

Operations posture of a resource such as activities, monitoring, backups, patching, and anomalies Security and Compliance posture of a resource such as threats, vulnerabilities, architectural drift, policy violations, and control violations of regulatory standards or industry standards cost posture of a resource such as unit rate, billing type, daily cost, monthly cost, budgets, optimization recommendations, reservations, and anomalies Access posture of a resource such as its utilization, visibility, violations, and recommendations Resource posture such as its implicit relationship, explicit relationship, dependencies, status, tags, SKUs, and locks Cloud resources have hierarchies and characteristics, and, for each hierarchy, multiple dimensions, dependencies, and implicit and explicit relationships with other cloud resources. These cloud resources also allow actions that are measured or influenced by cloud-native services or third-party tools. Hyperscalers provide details about each resource through discrete APIs. At this point, the Cloud Governance platform builds a 360-degree view of each of those resources. As noted supra, a cloud resource can have two views: an inside out view, and an outside in view. The inside out view provides characteristics, implicit relationships, explicit relationships, direct dependencies, indirect dependencies, and actions. The outside in view can be categorized across five essential areas: sustainability will soon be added as the sixth item on this list. The outside in view is achieved through OSCAR cloud governance model listed above, and the inside out view is achieved via Cloud Resource Modeling (CRM).

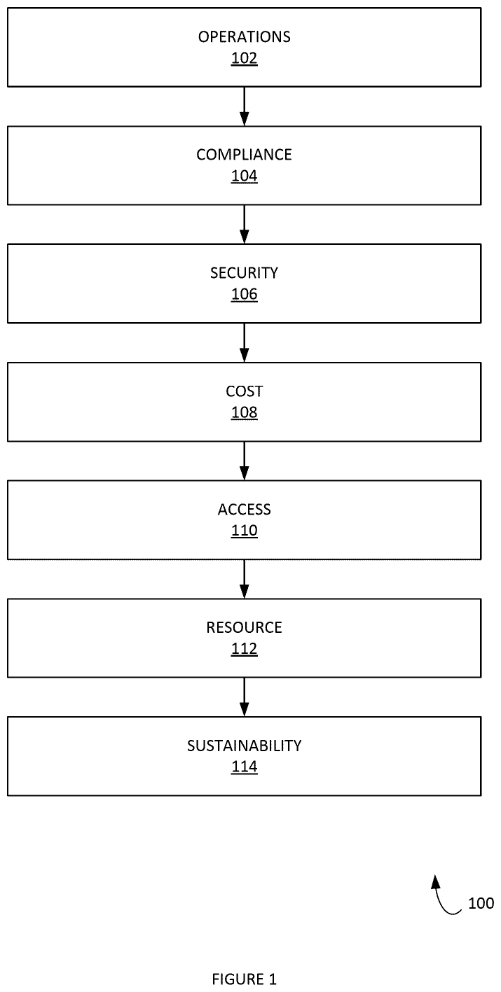

FIG. 1 illustrates an example schematic of an OSCAR governance model 100, according to some embodiments. Here OSCAR can include: operations posture of a resource such as activities, monitoring, backups, patching, and anomalies; security and compliance posture of a resource such as threats, vulnerabilities, architectural drift, policy violations, and control violations of regulatory standards or industry standards; cost posture of a resource such as unit rate, billing type, daily cost, monthly cost, budgets, optimization recommendations, reservations, and anomalies; access posture of a resource such as its utilization, visibility, violations, and recommendations; resource posture such as its implicit relationship, explicit relationship, dependencies, status, tags, SKUs, and locks

The different parts of the inside out view are now discussed. There can be a Cloud layer. This layer maintains the details of the service providers such as Amazon, Azure, Oracle Cloud, Google Cloud, etc., along with the account structure they offer, the APIs, the authentication model, automation, and orchestration offerings.

There can be a Product Category layer. Here, there can be services offered by the hyperscalers that are grouped under product categories. For example, AWS product categories include Compute, Containers, Network, Storage, Analytics, and Database.

There can be a Cloud Service layer. A cloud service is a product, application, or infrastructure available on the internet. Cloud services are typically classified as IaaS, PaaS, and SaaS. For example, the cloud services in AWS include EC2, S3, RDS, ECS, and Redshift.

There can be a Region layer. Hyperscalers offer their cloud services from multiple geographies to meet compliance, data sovereignty, and latency requirements. Each geography may have one or more regions and availability zones designed to help achieve reliability for business-critical workloads. Such discrete demarcations define disaster recovery and data residency boundaries across one or more regions. The Cloud Governance maintains multiple regions and ensures that customers are supported across the globe. For example, cloud regions in AWS include US-East and US-West, and cloud availability zones include US-East-1a and US-East-1b.

There can be a Resources layer. This can include Cloud resources in AWS include EC2-Instance, Security Group, Keypair, and Image.

Dependencies are now discussed. There are certain prerequisites for provisioning a resource, and dependencies outline these prerequisites. For example, VPC, Keypair, Security Group, and Image are prerequisites for provisioning an instance in AWS. Relationships between cloud resources are either explicit, which are defined at the hyperscaler, or implicit, which are derived.

An Explicit relationship can be a cloud resource may have one or more explicit relationships with other resources. Dependent resources are always a part of explicit relationships. The explicit relationship may be beyond the dependencies, and they may be one dimension or more than one dimension away. In one example, a relation to a relation is also a relation. Here are examples of explicit relationships for an instance in AWS. Volumes is not a dependent, but an explicit relation VPC is a dependency, and Internet Gateway is a relation to VPC and thus related to an instance Load Balancer for a VM is not a dependent but a relation to an instance.

Implicit relationships are now discussed. An implicit relationship from one cloud resource to another is derived via the network data flow between the resources rather than through regular hyperscaler APIs. Here are examples of implicit relationships for an instance in AWS as follows. Application server communicating to a database server Application server reading data from S3 Application server reading data from SQS or sending notification through SNS. The Cloud Governance platform provides a holistic 360-degree view of all cloud resources from the perspective of cost, compliance, security, policy, operations, assessments, and so on, both from outside in and inside out. As a result, we can provide different capabilities such as FinOps, SecOps, CloudOps, and Well-Architected Assessments using one platform. If a change is made within a cloud resource, that change is reflected across the entire portfolio of capabilities immediately. When the Cloud Governance platform combines the information we get from the discovered cloud resources with billing data to create CR360, it is much more powerful than leveraging billing data alone. However, the Cloud Governance platform is not limited to data from hyperscalers. Any piece of data that is associated with a cloud resource can be captured, whether it comes from a hyperscaler or a connected third-party tool. The Cloud Governance platform has the ability to poll data from tools such as monitoring and vulnerability, making it even richer and more beneficial. Regardless of the source, we can analyze and present that information in a single unified dashboard that provides recommendations, remediations, and deep insights to our customers.

Additionally, the data corpus that is created from all the anonymized cloud resources can be used to train AI models and generate recommendations for forecasting, right-sizing, predictions, and insights. The data can also be used for benchmarking how a customer in a particular industry in a particular region is leveraging cloud resources and comparing to others and can provide insights that facilitate the digital transformation journey and lead to better results.

Methods for future proofing the cloud-computing platform is now discussed. As the single system of intelligence for all cloud resources, The Cloud Governance platform can continuously and quickly adapt the platform, delivering new and enhanced cloud governance capabilities as technology evolves and as each of the hyperscalers change and add new capabilities to their respective cloud services. The Cloud Governance platform can implement them and expand what it means to say “Well-Architected,” and the Cloud Governance platform can integrate these new capabilities by leveraging the existing cloud resource. For the Cloud Governance platform, Well-Architected Assessment is yet another facet of the same cloud resource.

Another excellent example is sustainability, or what some people call GreenOps. A cloud resource may not provide data on the “greenness” of that resource today, but as hyperscalers make those capabilities available, the Cloud Governance platform can be able to leverage that data immediately, providing answers to questions like, “How green is this cloud resource? Is it powered by renewable energy? And how much more sustainable is the workload now that I am using green cloud resources?” While other providers will spend months playing catch-up on this front, the Cloud Governance platform enables quick alignment with hyperscaler developments. The Cloud Governance platform can extend cloud governance into every facet of the cloud as the need arises or as technology permits. The Cloud Governance platform provides yet another advantage when it comes to future-proofing. With today's enterprises rapidly embracing multiple cloud services, including IaaS, SaaS, and PaaS, as well as multiple operational tools such as monitoring, logging, security, configuration management, etc., there is an increasing need for efficient orchestration across these multiple services and tools.

Many organizations adopt cloud-native declarative domain-specific languages (DSLs) for provisioning and orchestration, but this approach has several limitations. Namely, cloud-native DSLs typically don't support discrete actions on cloud resources, don't support the orchestration of on-premises infrastructure or third-party tools, and only support the orchestration of services and resources native to the platform. The Cloud Governance platform can implement interoperable DSL that enables orchestration of multiple cloud platforms and services providers. This connectorless approach means that, as hyperscalers add more capabilities to their cloud offering and offer support for more standards, the Cloud Governance platform can quickly integrate those capabilities, bypassing the typical time-intensive development cycles that other vendor tools require.

An enterprise SaaS provider that focuses on FinOps or SecOps may offer deeper capabilities in that particular area, but today's enterprises would need four, five, six, seven, or eight such tools to provide all the cloud governance capabilities they require. And when these tools operate in isolation, the impact is sub-optimal, and the value of the cloud is dramatically reduced. A solution that provides integrated capabilities at the platform level via a single system of intelligence provides orders of magnitude more efficiency and more value. The Cloud Governance platform eliminates the need for integration of multiple functional siloed tools. In fact, it can replace a smorgasbord of tools and integrations with a single platform.

With the Cloud Governance platform, all cloud resources under management are fully integrated and all data is normalized, contextualized with both implicit and explicit relationships, and properly indexed. As a result, customers on the Cloud Governance platform realizes numerous benefits. With a 360-degree view across all cloud accounts along with valuable business context, the Cloud Governance platform also offers substantial benefits to leadership across the organization. By providing a holistic perspective of every interconnected facet of a cloud resource, The Cloud Governance platform allows a customer to optimize cloud usage within the context of cloud resource interdependencies across FinOps, SecOps, and CloudOps. The Cloud Governance platform brings together data from multiple hyperscalers for true multi-cloud governance for AWS, Azure, GCP, and OCI. A single system of intelligence is fed by—and operates across-all hyperscalers, consolidating all cloud data in a single pane of glass. The Cloud Governance platform is not limited to a single cloud resource. It also reflects relationships between cloud resources, such as hierarchy, dependencies, etc. The Cloud Governance platform data is not limited to that provided by hyperscalers. It can be further enriched with data from third-party tools. The Cloud Governance platform allows the platform to continuously adapt and evolve to accommodate whatever cloud technology and hyperscaler enhancements come next.

It is noted that enterprises are increasingly using various cloud platforms, each geared at providing differentiated value. Irrespective of the cloud platform, there are common pillars and principles that guide enterprises in defining, building, and enforcing cloud guardrails for efficient governance. Cloud Operations, Security, Cost, Access, and Resource (OSCAR) consistency can form the core pillars of cloud governance. OSCAR can form the foundation for continuous and autonomous cloud governance. OSCAR governance model augments cloud-native governance by offering key benefits, including, inter alia: unified visibility and insights rule-based automation to govern the entire cloud landscape, automated remediation to resolve the governance gaps, quantify governance with indexing and benchmarking, seamless integration with an enterprise tool ecosystem, built on cloud-native services, etc.

The OSCAR governance model leverages a Cloud-as-Code approach that uses deep AI/ML, declarative definitions, and a cloud service-chaining technology. Process 100 can cover details on each of the pillars of the OSCAR model in the upcoming blogs.

Cloud visibility can be an important element of the OSCAR cloud governance model. Two main aspects of cloud inventory include, inter alia: Inventory Discovery and Inventory Management. Process 100 can use cloud resource inventory to maintain inventory items along with categories across platforms, accounts, and regions. It can be useful to maintain a centralized cloud inventory database that includes cloud resource metadata, resource state, and the relationship between resources. For example, for a VM the related resources can be VPC, Subnet, and a Security Group.

Process 100 can be used to implement enterprise cloud compliance and discover dynamic cloud inventory. Inventory-related services offered by cloud service providers can be a good starting point. However, as the cloud consumption increases with multiple accounts/subscriptions, users, and importantly multiple clouds, the native services may not suffice the enterprise needs. Cloud Inventory view by organization hierarchy (e.g. various users, user groups, and levels) can be desirable as well. In a multi-cloud environment, a single pane of glass view with an ability to drill down further by resource types (e.g. compute, storage, and network) and tags adds significant value. If a third-party multi-cloud governance solution is adopted, ensure that even the cloud resources on-boarded directly from the cloud console show up dynamically on the inventory dashboard.

More specifically, in step 102, process 100 can implement operations governance operations. Operations governance can be used to monitor alerts and remediation. Operations governance can be used to implement activity tracking. Operations governance can be used for backup and restore operations. Operations governance can be used for patch management. Patch management can be used for security governance through Enterprise Cloud Governance.

Operations Governance can eliminate cloud silos, leverage automation, and gain deeper insights into your cloud operations. In this way, an entity can avoid cloud outages and improve efficiencies. Operations Governance can be used in Enterprise Cloud Governance (ECG) Operations to build guardrails to secure a cloud proactively. Operations Governance can used to attain real-time security posture and trend analysis. Operations Governance can used to detect security gaps and policy violations and fix them before they transform to business threats.

In step 104, process 100 can implement compliance operations (e.g. such as those discussed supra, etc.).

In step 106, process 100 can implement Security Governance operations. This can include a governance posture to handle threats and vulnerabilities by cloud, account, tenant, and type. This can include cost governance with deeper visibility and insights. Security Governance can be used to manage cost governance in the cloud as costs can spiral upwards in little time. Security Governance operations can put a stop to cloud waste by continually discovering and eliminating inefficient resources. Security Governance operations can build accountability with budget controls and charge-backs.

In step 108, process 100 can implement cost optimization (e.g. for budget controls, charge-backs, etc.).

In step 110, process 100 can implement Access Governance operations. Access Governance can provide visibility and insights by user, service, role, and policy. This can be used for access utilization and violations. Access Governance operations can be used in ECG to prevent access creep and/or privilege creep that manifests as enterprises navigate cloud journey. Access Governance operations can be used to gain deeper insights into your cloud access and build access governance based on the principle of least privilege. Access Governance operations can be used to, inter alia, define, enforce, and track the resource naming and tagging standards, sizing, and their usage by regions. Access Governance operations can follow consistent and standard practices pertaining to resource deployment, management, and reporting.

In step 112, process 100 can implement Resource Governance operations. Resource Governance can provide comprehensive visibility of Inventory. Resource governance operations can be used for tagging and naming standards. Resource locks can also be implemented. Process 100 can also implement automation of resource discovery. Process 100 can manage scheduling and notifications (e.g. templates and scripts, etc.). In step 114, process 100 can implement sustainability operations.

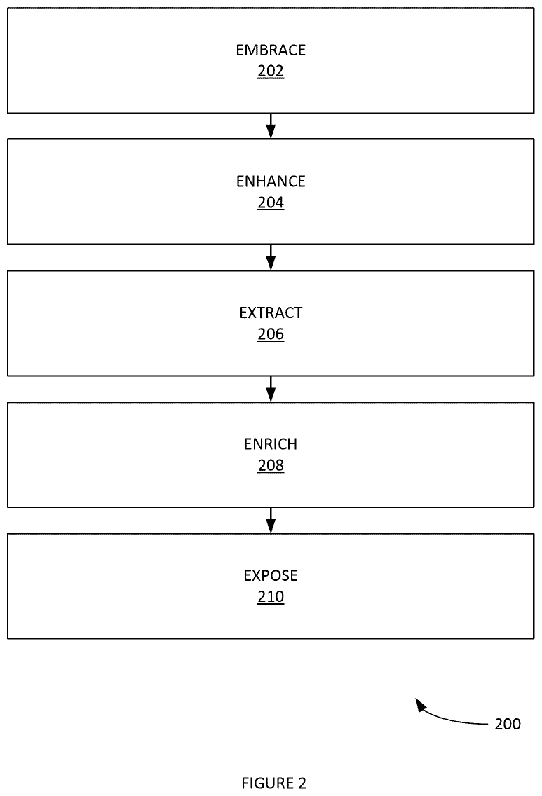

FIG. 2 illustrates an example system for enriching cloud resources, according to some embodiments. Example Cloud Governance platform capabilities are now discussed. To get a full perspective of CR360, let's look at ten powerful capabilities CR360 enables. With CR360, a customer can proactively monitor cloud systems against customized cost guardrails, allowing the customer to spot drift in cloud spending in real-time, trigger notifications and auto-remediation, and prevent cost overruns without requiring human intervention. The Cloud Governance platform can identify and act on cost optimization opportunities such as right-sizing, matching resources to workloads, identifying and remediating idle and orphaned cloud resources, customizing configurations, and managing markups and discounts.

Granular cost reporting and tools can help foster a culture of financial accountability. The Cloud Governance platform allows a customer to govern security operations proactively and autonomously, building a strong defense against security threats. The Cloud Governance platform provides a unified visibility into security threats, attacks, and vulnerability data, identifying threats and assessing vulnerabilities continuously against security governance guardrails.

The Cloud Governance platform provides an accurate and unified view of the entire multi-cloud inventory and compliance status, enabling a customer to achieve continuous cloud compliance against evolving industry and regulatory standards. The Cloud Governance platform assess a customer's cloud infrastructure against industry standards such as ISO, FedRAMP, NIST, HIPAA, PCI-DSS, CIS, AWS Well-Architected Framework, and specified customized standards.

The Cloud Governance platform can enable compliance with built-in support for more than 2,000 policies across 22 standards—and the ability to create even more through customization. The Cloud Governance platform makes it easy to assess, remediate (e.g. where the hyperscaler allows), and ensure compliance with policies across multiple cloud platforms, whether for operations, cost, security, or compliance.

With rules-based automation, third-party integrations, continuous monitoring, and single-pane-of-glass visibility, the Cloud Governance platform provides smarter operations across cloud platforms, increasing efficiency, productivity, reliability, and flexibility across activities such as monitoring, backups, patching, and remediation.

The Cloud Governance platform includes a Well-Architected Assessment that helps enterprises adopt cloud best practices, manage risk, and maintain reliable, secure, resilient, cost-efficient, performant, and sustainable cloud infrastructures. The Cloud Governance platform can enable evolutions and applying them across other disciplines, whether cost, compliance, security, or operations. Further, the Cloud Governance platform enables customers to create their own custom assessment frameworks, alongside the ones provided by hyperscalers, and to fine-tune the assessments that suit their enterprise.

It is noted that a workload in is a group of related cloud resources, and it's created for the purpose of aiding in governance and yielding insights about their performance. When a customer creates a workload, the Cloud Governance platform discovers all the resources available in the cloud account and allows a customer to filter and select which resources the customer wants to associate with particular workloads. The customer can also apply assessments from a specific Well-Architected Framework to a workload.

In one example, two cloud resources are associated with each other in a relationship where one cloud resource uses a second cloud resource for a project. The Cloud Governance platform can connect those two resources, understand the primary and secondary relationship between them, and understand how they are hierarchically connected. The Cloud Governance platform provides is not just about seeing different facets of a single cloud resource, but seeing multiple facets of each cloud resource and how they relate together and across projects.

By capturing relationships such as parent-child dependencies, the Cloud Governance platform can determine how many cloud resources belong to a particular project, how much the resources for a particular project cost, and, if the customer takes a cloud resource away, precisely how the project will be impacted. Dependencies let us optimize within that context, even if the cloud resource or project spans multiple cloud accounts.

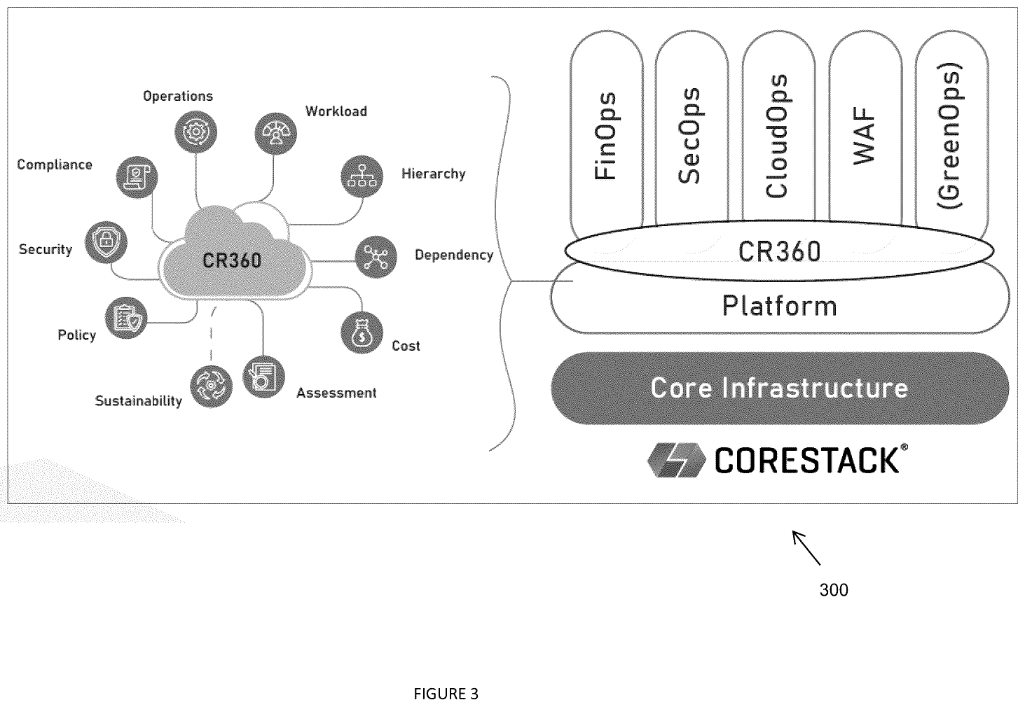

FIG. 3 illustrates an example schematic showing Cloud Governance platform capabilities, according to some embodiments. The Cloud Governance platform help enterprises leverage best-of-breed cloud providers with the least friction possible. The Cloud Governance platform provides a NextGen Cloud Governance platform that allows enterprises to embrace, enhance, and extend native cloud capabilities while providing reporting, recommendation, and auto-remediation in a unified dashboard across the most complex and multi-cloud environments. Armed with powerful FinOps, SecOps, CloudOps, and Well-Architected Assessment capabilities, enterprises can more quickly and easily capitalize on the opportunities that matter. The Cloud Governance platform can be built from the ground-up as an enterprise SaaS product to provide comprehensive multi-cloud governance.

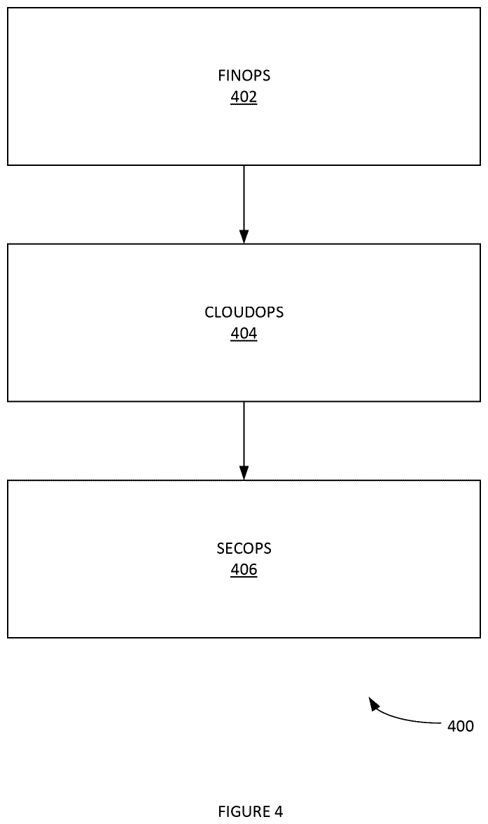

FIG. 4 illustrates an example process 400 for multi-cloud platform governance, according to some embodiments. In step 402, process 400 implements Finops. FinOps focuses on driving financial accountabilities for all stakeholders across finance, product, and procurement teams to get the benefits of both agile development and forecast-able cloud consumption. Adopting FinOps allows organizations to ensure they are getting the most efficient use of their cloud consumption through repeatable processes, unified key performance indicators (KPIs), and the ability to understand the business value of their cloud spend through unit economics. FinOps is a solution offering designed to help the customer develop a culture of financial accountability and realize the benefits of the cloud faster. It accomplishes this through a set of features, tools, and capabilities that enable the customer to improve predictability, prevent budget overruns, and make more data-driven business decisions. Some key features and benefits of FinOps include: Granular visibility and insights into resource utilization and costs. Action-oriented, multi-cloud, multi-dimensional reports including daily/monthly cost view, consolidated charges, charge-back reports, and more. End-to-end workflow integration with IT service management (ITSM) tools such as ServiceNow and Jira.

In step 404, process 400 implements Cloudops. CloudOps refers to the process of managing and optimizing IT workloads in the cloud in order to keep essential infrastructure and applications running. CloudOps combines the functions of cloud architecture, software engineering, security, compliance, and IT operations to provide better accessibility, availability, and business outcomes. Essentially, it's a combination of IT operations and DevOps principles applied to the cloud to help improve and accelerate business processes. With the help of a solid strategy, enterprises can automatically provision virtual machines, perform automatic backup, recovery, and patching activities, and streamline their workflows. CloudOps is a solution offering designed to help optimize cloud operations and cost management in order to provide enhanced accessibility, availability, flexibility, and efficiency while also boosting business agility. It accomplishes this by reducing cloud expenses through optimized resource utilization, increasing business opportunities through compliance with industry standards and regulations, and improving productivity through workflows that integrate seamlessly with third-party tools. Some key features and benefits of CloudOps include: Tools that help to continuously assess the maturity of operations, gain visibility, and integrate with custom enterprise workflows. Cross-cloud standardization, automation, governance, and single-pane-of-glass visibility. Rule-based automation for monitoring, alerts and remediation, activity tracking, backup, restore, and patch management. Baselining cloud resources to automatically identify drifts and deviations for compliance and governance. Extensive support for templates and blueprint scheduling via third-party tool integration. Automation and standardization of processes that help to minimize human dependency and eliminate manual errors that impact service availability and performance.

In step 406, process 400 implements Secops. SecOps refers to the combination of efforts from security and operations teams to monitor the security posture of cloud assets, assess their risks, and protect them. As an enterprise scales and adopts cost-effective cloud computing models, security operations will play a foundational role in mitigating risks across a business environment. This is becoming increasingly important amid the growing rate of cyberattacks, like ransomware, targeting businesses of all sizes. SecOps is a solution offering designed to help keep the cloud assets secure and compliant. It accomplishes this through cloud-native tools and custom APIs, including autonomous security operations, unified visibility into threats and vulnerabilities, and compliance assessments-applied across the entire multi-cloud inventory. Some key features and benefits of SecOps include: Automated processes that can be run across the entire multi-cloud inventory to achieve continuous cloud compliance with evolving industry and regulatory standards. Unified visibility into security threats and vulnerabilities, and the ability to remediate them. Compliance assessments can run using unique Abstracted Cloud Compliance Control (AC3) engine for industry standards, such as ISO, FedRAMP, NIST, HIPAA, PCI DSS, CIS Azure, CIS AWS, and AWS Well-Architected Framework.

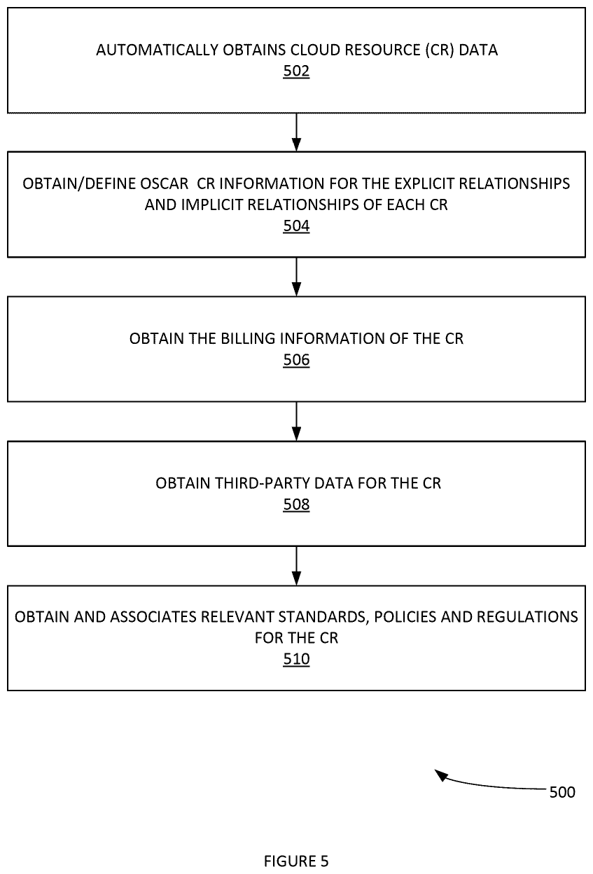

FIG. 5 illustrates an example process 500 for explicit and implicit cloud-resource data extraction with a multi-cloud governance platform, according to some embodiments. In step 502, process 500 automatically obtains cloud resource (CR) data. This can include, inter alia, cost profile, dependency list, operational profile, implicit, CR has a particular workload, etc. of a client's account. In one example, a dependency can be defined for a virtual machine (VM) that is using a specific data store. Process 500 can obtain/define OSCAR CR information for the explicit relationships and implicit relationships of each CR in step 504. Implicit relationships are derived from connections of the CR. In step 506, process 500 obtains the billing information of the CR. In step 508, process 500 obtains third-party data for the CR (e.g. APPdynamics, Service Now, JIRA, etc.). In step 510, process 500 obtains and associates relevant standards, policies and regulations for the CR. These can also be defined by the customer. Process 500 can also obtain relevant regions and/or other geographical data relevant to the CR. Process 500 obtains a wholistic view of the CR. Process 500 can obtain curated data from the hyperscaler. This data is then standardized and put into a common context across hyperscalers. This is included in addition to the explicit and implicit data.

For example, a CR utilizes a specified network or connects to a specified device through a certain port, etc. Process 500 can build FinOps based on explicit relationships, implicit relationships and billing information. Process 500 can implement ‘discovery’ for a CR account and utilize one or more APIs provided by a cloud provider to obtain CR data. This can include user profile (via APIs) and billing data. Process 500 can obtain curated properties not available through APIs as well. This can be done by manual review creating a master data with additional curated properties about a CR. This data can be used to derive the implicit relationships.

### Additional Example Computer Architecture and Systems

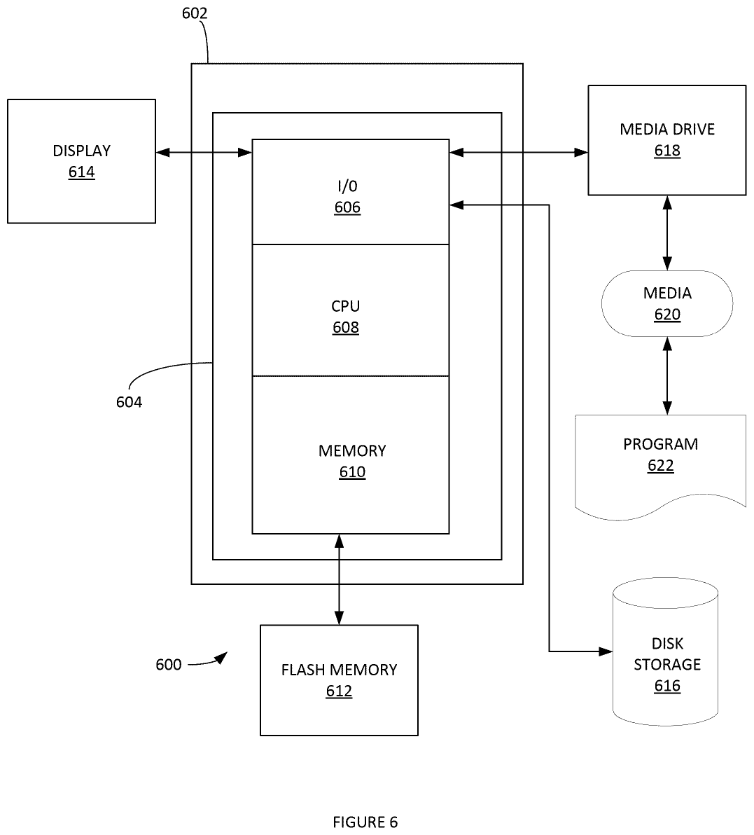

FIG. 6 depicts an exemplary computing system 600 that can be configured to perform any one of the processes provided herein. In this context, computing system 600 may include, for example, a processor, memory, storage, and I/O devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform any of the processes described herein. The main system 602 includes a motherboard 604 having an I/O section 606, one or more central processing units (CPU) 608, and a memory section 610, which may have a flash memory card 612 related to it. The I/O section 606 can be connected to a display 614, a keyboard and/or other user input (not shown), a disk storage unit 616, and a media drive unit 618. The media drive unit 618 can read/write a computer-readable medium 620, which can contain programs 622 and/or data. Computing system 600 can include a web browser. Moreover, it is noted that computing system 600 can be configured to include additional systems in order to fulfill various functionalities. Computing system 600 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed is:

1. A computerized method for explicit and implicit cloud-resource data extraction with a multi-cloud governance platform comprising:
providing a plurality of cloud resources;
automatically obtaining a cloud resource data for each cloud resource in the plurality of cloud resources;
defining a set of Cloud Operations, Security, Cost, Access, and Resource (OSCAR) cloud resources information for a plurality of explicit relationships and a plurality of implicit relationships of each cloud resource of the plurality of cloud resource;
defining a plurality of implicit relationships that are derived from a plurality of connections of each cloud resource;
obtaining a billing information of each cloud resource;
obtaining a third-party data for the cloud resource;
obtaining and associating a plurality of relevant standards, policies and regulations for each cloud resource;
obtaining one or more relevant regions and other geographical data relevant to each cloud resource; and
with the plurality of implicit relationships that are derived from a plurality of connections of each cloud resource, the billing information of each cloud resource, the third-party data for the cloud resource plurality of relevant standards, the policies and regulations for each cloud resource, and the one or more relevant regions and other geographical data relevant to each cloud resource, generating a wholistic view of each cloud resource.

2. The method of claim 1, wherein the step of automatically obtaining the CR data further comprises:
obtaining a cost profile list, a dependency list, and an operational profile.

3. The method of claim 2, wherein the CR comprises a particular workload of a client's account.

4. The method of claim 3, wherein a dependency is defined for a virtual machine (VM) that is using a specific data store.

5. The method of claim 4, wherein the OSCAR governance model augments a plurality of cloud-native governance operations.

6. The method of claim 5, wherein the plurality of cloud-native governance operations comprises a unified visibility and insights rule-based automation to govern the entire cloud landscape.

7. The method of claim 6, wherein the plurality of cloud-native governance operations comprises an automated remediation to resolve at least one governance gaps.

8. The method of claim 7, wherein the plurality of cloud-native governance operations comprises a quantify cloud-governance with one or more indexing and benchmarking operations for a cloud platform.

9. The method of claim 8, wherein the plurality of relevant standards, policies and regulations for each cloud resource further are defined by a customer.

10. The method of claim 9, wherein each cloud resources utilizes a specified network or connects to a specified device through a certain port.

11. The method of claim 10 further comprising:
building a FinOps governance model based on the plurality of explicit relationships, the plurality of implicit relationships and the billing information.

12. The method of claim 11 further comprising:
implementing a discovery for a cloud-resource account.

13. The method of claim 12 further comprising:
utilizing one or more APIs provided by a cloud provider to obtain a cloud-resource data.

14. The method of claim 13, wherein the step of utilizing one or more APIs provided by a cloud provider to obtain a cloud-resource data comprises a user profile obtained via the one or more APIs and the billing data.

15. The method of claim 12 further comprising:
obtaining a plurality of curated properties not available through APIs, wherein the plurality of curated properties is obtained by a review that generates a master data with additional curated properties about each cloud resource.

16. The method of claim 15, wherein each curated property is from a hyperscaler.

17. The method of claim 16, wherein the plurality of curated properties is standardized and put into a common context across a plurality of hyperscalers and is included in addition to the explicit and implicit data.
